(19) United States
(12) Patent Application Publication
(10) Pub. No.: US 2025/0246940 A1
(43) Pub. Date: Jul. 31, 2025

(54) SWITCH CONTROL APPARATUS, LIGHT FEEDING SYSTEM AND SWITCH CONTROL METHOD

(71) Applicant: NIPPON TELEGRAPH AND TELEPHONE CORPORATION, Tokyo (JP)

(72) Inventors: Kenta ITO, Musashino-shi, Tokyo (JP); Hiroaki KATSURAI, Musashino-shi, Tokyo (JP); Tomoaki YOSHIDA, Musashino-shi, Tokyo (JP)

(73) Assignee: NIPPON TELEGRAPH AND TELEPHONE CORPORATION, Tokyo (JP)

(21) Appl. No.: 18/699,803

(22) PCT Filed: Oct. 12, 2021
(86) PCT No.: PCT/JP2021/037701

§ 371 Date: Apr. 9, 2024

(51) Int. Cl. H02J 50/30; H02J 50/40

(52) U.S. Cl. CPC H02J 50/30; H02J 50/40

(57) ABSTRACT

A switch control apparatus includes a switch control unit that connects a plurality of optical power feeding devices and a plurality of optical power reception devices that convert light received from the plurality of optical power feeding devices into power and store the power, and controls an optical power supply switch that switches an emission destination of light emitted from the optical power feeding devices, a power storage data reception unit that receives data of a power storage amount stored by the plurality of optical power reception devices, and
a distribution determination unit that determines a distribution of light emitted from the plurality of optical power feeding devices to the plurality of optical power reception devices based on data of the power storage amount received by the power storage data reception unit, in which the switch control unit controls the optical power supply switch based on the distribution determined by the distribution determination unit.

### TECHNICAL FIELD

The present invention relates to a switch control apparatus, an optical power feeding system, and a switch control method.

### BACKGROUND ART

Patent Literature 1 discloses an optical power feeding system. The optical power feeding system disclosed in Patent Literature 1 includes a plurality of light sources, a plurality of first optical fibers that respectively transmit light output from the plurality of light sources, an optical coupler that multiplexes the light transmitted from the first optical fiber and branches and outputs the multiplexed light, a second optical fiber that transmits the multiplexed light output from the optical coupler, and a power generation unit that receives the light transmitted from the second optical fiber and generates power.

### CITATION LIST

### Patent Literature

Patent Literature 1: JP 2005-198396 A

### SUMMARY OF INVENTION

### Technical Problem

In the optical power feeding system described in Patent Literature 1, the optical coupler is an N: N coupler, and the intensity of light of the light source per optical fiber is about 1/N. Therefore, even if all the light on the output side is collected, the intensity of the light does not exceed the intensity of the light per light source, and in some cases, the efficiency may be inferior to that of supplying power by directly connecting the light source and the power receiver.

An object of the present invention is to provide a switch control apparatus capable of efficiently performing optical power feeding.

### Solution to Problem

An aspect of the present invention is a switch control apparatus including a switch control unit that connects a plurality of optical power feeding devices and a plurality of optical power reception devices that convert light received from the plurality of optical power feeding devices into power and store the power, and controls an optical power supply switch that switches an emission destination of light emitted from the optical power feeding devices, a power storage data reception unit that receives data of a power storage amount stored by the plurality of optical power reception devices, and a distribution determination unit that determines a distribution of light emitted from the plurality of optical power feeding devices to the plurality of optical power reception devices based on data of the power storage amount received by the power storage data reception unit, in which the switch control unit controls the optical power supply switch based on the distribution determined by the distribution determination unit.

An aspect of the present invention is an optical power feeding system including a plurality of optical power feeding devices that transmit light, a plurality of optical power reception devices that convert light received from the plurality of optical power feeding devices into power and store the power, an optical power supply switch that connects the plurality of optical power feeding devices and the plurality of optical power reception devices and switches an emission destination of light emitted from the optical power feeding devices, a switch control unit that controls the optical power supply switch, a power storage data reception unit that receives data of a power storage amount stored by the plurality of optical power reception devices, and a distribution determination unit that determines a distribution of light emitted from the plurality of optical power feeding devices to the plurality of optical power reception devices based on data of the power storage amount received by the power storage data reception unit, in which the switch control unit controls the optical power supply switch based on the distribution determined by the distribution determination unit.

An aspect of the present invention is a switch control method including a switch control step of connecting a plurality of optical power feeding devices and a plurality of optical power reception devices that convert light received from the plurality of optical power feeding devices into power and store the power, and controlling an optical power supply switch that switches an emission destination of light emitted from the optical power feeding devices, a power storage data reception step of receiving data of a power storage amount stored by the plurality of optical power reception devices, and a distribution determination step of determining a distribution of light emitted from the plurality of optical power feeding devices to the plurality of optical power reception devices based on data of the power storage amount received by the power storage data reception step, in which in the switch control step, the optical power supply switch is controlled based on the distribution determined in the distribution determination step.

### Advantageous Effects of Invention

The switch control apparatus of the present invention can efficiently perform optical power feeding.

### BRIEF DESCRIPTION OF DRAWINGS

FIG. 1 is a diagram illustrating an optical power feeding system according to a first embodiment.

FIG. 2 is a diagram illustrating an optical power reception device according to the first embodiment.

FIG. 3 is a diagram illustrating a configuration of a switch control apparatus according to the first embodiment.

FIG. 4 is an example of an optical power supply switch controlled by the switch control apparatus.

### DESCRIPTION OF EMBODIMENTS

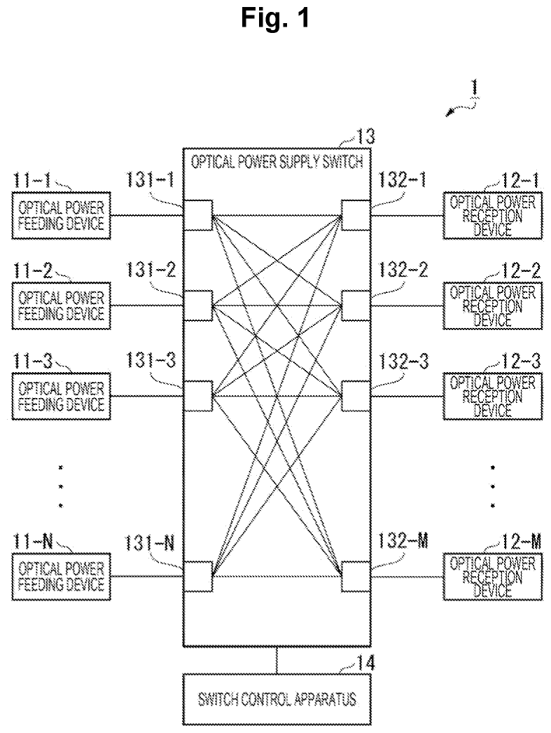

FIG. 1 is a diagram illustrating an optical power feeding system 1 according to a first embodiment.

The optical power feeding system 1 includes an optical power feeding device 11, an optical power reception device 12, an optical power supply switch 13, and a switch control apparatus 14.

The optical power feeding device 11 transmits light to the optical power supply switch 13. The optical power feeding device 11 is, for example, an optical line terminal (OLT). The optical power feeding system 1 includes N (N is an integer of 2 or more) optical power feeding devices 11-1 to N.

The optical power reception device 12 receives light from the optical power supply switch 13. The optical power reception device 12 is, for example, an optical network unit (ONU). When the optical power feeding device 11 is an OLT and the optical power reception device 12 is an ONU, the optical power feeding device 11 and the optical power reception device 12 may transmit and receive data by another connection method not via the optical power supply switch 13.

The optical power feeding system 1 includes M (M is an integer of 2 or more) optical power reception devices 12-1 to M. M may be a value equal to N or a different value.

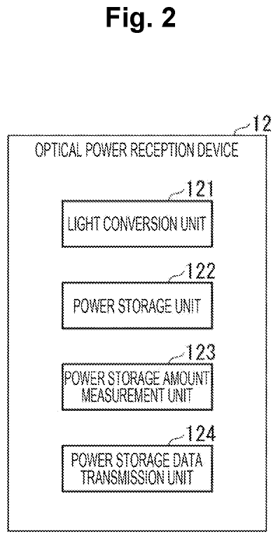

FIG. 2 is a diagram illustrating the optical power reception device 12 according to the first embodiment. The optical power reception device 12 includes a light conversion unit 121, a power storage unit 122, a power storage amount measurement unit 123, and a power storage data transmission unit 124.

The light conversion unit 121 converts received light into power. The light conversion unit 121 is, for example, a photodiode. The power storage unit 122 stores the electric power converted by the light conversion unit 121. The power storage unit 122 is, for example, a battery. In addition, the power storage amount measurement unit 123 and the power storage data transmission unit 124 included in the optical power reception device 12 are driven by the power stored in the power storage unit 122. When the optical power reception device 12 is an ONU, the power stored in the power storage unit 122 may be consumed for the optical power reception device 12 to transmit and receive data.

The power storage amount measurement unit 123 measures the power storage amount of the power storage unit 122. The power storage data transmission unit 124 transmits data of the power storage amount measured by the power storage amount measurement unit 123 to the switch control apparatus 14. The power storage data transmission unit 124 may transmit the data of the power storage amount to the switch control apparatus 14 via, for example, connection means provided separately from the optical power supply switch 13 that connects the optical power reception device 12 and the switch control apparatus 14. In addition, the optical power supply switch 13 may include an optical circulator that outputs light input from the optical power feeding device 11 to the optical power reception device 12 and outputs light input from the optical power reception device 12 to the switch control apparatus 14, and the power storage data transmission unit 124 may transmit an optical signal including data of the power storage amount to the switch control apparatus 14 via the optical power supply switch 13.

The optical power supply switch 13 connects the optical power feeding device 11 and the optical power reception device 12, and switches a connection relationship between the optical power feeding devices 11 and the optical power reception devices 12. The optical power supply switch 13 is configured such that any optical power reception device 12 can receive the light transmitted from the optical power feeding device 11. The optical power supply switch 13 includes, for example, a 1-input M-output switch that has one input and M outputs and can control from which of the M outputs the input light is output, and an N-input 1-output coupler that has N inputs and one output and multiplexes and outputs a plurality of input lights. In order to suppress the loss due to the N-input 1-output coupler, mode multiplexing, polarization multiplexing, or wavelength multiplexing is used for multiplexing of light by the N-input 1-output coupler.

The optical power supply switch 13 includes N 1-input M-output switches 131 and M N-input 1-output couplers 132. The inputs of the 1-input M-output switch 131 are connected to different optical power feeding devices 11. The M outputs of the 1-input M-output switch 131 are connected to different inputs of the N-input 1-output coupler 132 for each output. The inputs of the N-input 1-output coupler 132 are connected to 1-input M-output switches 131 different from each other by one input. The outputs of the N-input 1-output coupler 132 are connected to different optical power reception devices 12.

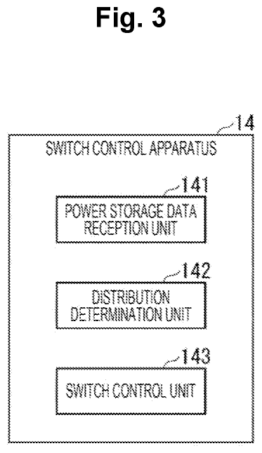

The switch control apparatus 14 is included in the optical power supply switch 13 or connected to the optical power supply switch 13, and controls switching of the optical power supply switch 13. FIG. 3 is a diagram illustrating a configuration of a switch control apparatus 14 according to the first embodiment. The switch control apparatus 14 includes a power storage data reception unit 141, a distribution determination unit 142, and a switch control unit 143. The power storage data reception unit 141 receives data indicating the power storage amount from the power storage data transmission unit 124 of the optical power reception device 12.

The distribution determination unit 142 determines a distribution of light emitted from the plurality of optical power feeding devices to the plurality of optical power reception devices based on the data of the power storage amount received by the power storage data reception unit. The distribution determination unit 142 determines the distribution such that light is transmitted from more optical power feeding devices 11 to the optical power reception device 12 in which the power storage amount of the power storage unit 122 is small. For example, when the power storage amount of the power storage unit 122 is 75% to 100%, the distribution determination unit 142 determines the distribution such that light is not transmitted from the optical power feeding device 11 to the optical power reception device 12 including the power storage unit 122. For example, when the power storage amount of charge of the power storage unit 122 is 50% to 75%, the distribution determination unit 142 determines the distribution such that light is transmitted from one optical power feeding device 11 to the optical power reception device 12 including the power storage unit 122. For example, when the power storage amount of charge of the power storage unit 122 is 25% to 50%, the distribution determination unit 142 determines the distribution such that light is transmitted from the two optical power feeding devices 11 to the optical power reception device 12 including the power storage unit 122. For example, when the power storage amount of charge of the power storage unit 122 is 0% to 25%, the distribution determination unit 142 determines the distribution such that light is transmitted from the three optical power feeding devices 11 to the optical power reception device 12 including the power storage unit 122.

The distribution determination unit 142 may determine the distribution as follows. First, the distribution determination unit 142 calculates a difference between the power storage amount of charge of the power storage unit 122 and the full power storage amount of charge of the power storage unit 122. This difference is referred to as a necessary power feeding amount. Thereafter, the distribution determination unit 142 calculates the sum of the necessary power feeding amounts (total necessary power feeding amount) in each power storage unit 122. Thereafter, for each power storage unit 122, the distribution determination unit 142 temporarily determines a value obtained by multiplying the number N of the optical power feeding devices 11 by the ratio of the necessary power feeding amount to the total necessary power feeding amount (the number obtained by dividing the necessary power feeding amount of the power storage unit 122 by the total necessary power feeding amount) as the number of the optical power feeding devices 11 allocated to the power storage unit 122. Since there is a possibility that the number provisionally determined here is not an integer, the distribution determination unit 142 determines the number (integer) of the optical power feeding device 11 based on the finally provisionally determined number.

Here, for example, the distribution determination unit 142 may truncate the number of decimal places of the provisionally determined number and allocate the unallocated optical power feeding device 11 to the power storage unit 122 having a large necessary power feeding amount, or may allocate the unallocated optical power feeding device 11 to the power storage unit 122 having a small necessary power feeding amount.

The switch control unit 143 controls the optical power supply switch based on the distribution determined by the distribution determination unit 142. In a case where the distribution determined by the distribution determination unit 142 cannot be achieved, the switch control unit 143 may control the optical power supply switch 13 so that light is transmitted from the plurality of optical power feeding devices 11 to the optical power reception device 12 including the power storage unit 122 having a small power storage amount.

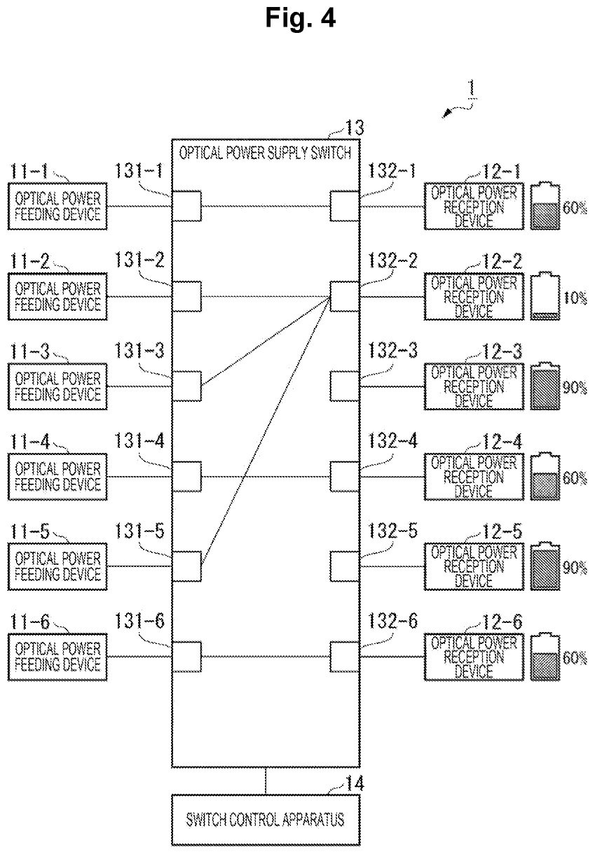

FIG. 4 is an example of connection by the optical power supply switch 13 controlled by the switch control apparatus 14. In the optical power feeding system 1 illustrated in FIG. 4, N=M=6. That is, the optical power feeding system 1 includes six optical power feeding devices 11 and six optical power reception devices 12. The power storage amount of the power storage units 122-3 and 122-5 of the optical power reception devices 12-3 and 12-5 is 90%. The power storage amount of the power storage units 122-1, 122-4, and 122-6 of the optical power reception devices 12-1, 12-4, and 12-6 is 60%. The power storage amount of the power storage unit 122-2 of the optical power reception device 12-2 is 10%. Here, the distribution determination unit 142 determines not to transmit light from the optical power feeding device 11 to the optical power reception devices 12-3 and 12-5, determines to transmit light from one optical power feeding device 11 to the optical power reception devices 12-1, 12-4, and 12-6, and determines to transmit light from three optical power feeding devices 11 to the optical power reception device 12-2.

As illustrated in FIG. 4, the switch control unit 143 controls the optical power supply switch 13 in order to connect the optical power feeding device 11 and the optical power reception device 12. The lines depicted in the optical power supply switch 13 of FIG. 4 illustrate the fibers through which the light transmitted by the optical power feeding device 11 transmits. The switch control unit 143 controls the optical power supply switch 13 so that light transmitted from the optical power feeding device 11-1 is transmitted to the optical power reception device 12-1, light transmitted from the optical power feeding devices 11-2, 11-3, and 11-5 is transmitted to the optical power reception device 12-2, light transmitted from the optical power feeding device 11-4 is transmitted to the optical power reception device 12-4, and light transmitted from the optical power feeding device 11-6 is transmitted to the optical power reception device 12-6.

With the above configuration, the switch control apparatus 14 can transmit light from a larger number of optical power feeding devices 11 to the optical power reception device 12 including the power storage unit 122 having a small power storage amount by controlling the optical power supply switch 13. Accordingly, it is possible to efficiently charge the power storage unit 122.

### OTHER EMBODIMENTS

The optical power feeding device 11 may designate the optical power reception device 12 as the transmission destination. At this time, the optical power feeding device 11 may transmit a signal to the switch control apparatus 14 via a connection unit provided separately from the optical power feeding system 1. In addition, the optical power supply switch 13 may include a filter that switches the transmission destination of the light input from the optical power feeding device 11 to the optical power reception device 12 and the switch control apparatus 14 according to the wavelength of the light, and the optical power feeding device 11 may transmit an optical signal having a wavelength different from the wavelength of the light transmitted to the optical power reception device 12 to the switch control apparatus 14 via the optical power supply switch 13. When receiving the signal or the optical signal, the switch control apparatus 14 controls the optical power supply switch 13 such that the switch control unit 143 transmits light to the optical power reception device 12 designated by the optical power feeding device 11.

The optical power feeding device 11 may have a configuration corresponding to the switch control apparatus 14, and may designate the optical power reception device 12 as a transmission destination. At this time, each optical power feeding device 11 includes a power storage data reception unit 141 and a switch control unit 143. The power storage data reception unit 141 may receive the data of the power storage amount from the power storage data transmission unit 124 via a connection unit provided separately from the optical power supply switch 13. In addition, in a case where an optical signal including data on the power storage amount is generated by modulating a part of light received by the optical power reception device 12 and the optical signal is transmitted to the optical power feeding device 11, the power storage data reception unit 141 may receive the optical signal via the optical power supply switch 13.

The switch control unit 143 provided in each optical power feeding device 11 controls the optical power supply switch 13 according to the optical power reception device 12 to which each optical power feeding device 11 sends out.

One distribution determination unit 142 is provided inside or outside the optical power reception device 12. The distribution determination unit 142 receives the power storage data from each optical power reception device 12, determines distribution, and transmits data related to the determined distribution to the switch control unit 143.

The power storage data reception unit 141 may acquire a measurement result by the power storage amount measurement unit 123 of the optical power reception device 12 via the optical power supply switch 13 or via a connection unit provided separately from the optical power feeding system 1. At this time, the optical power reception device 12 may not include the power storage data transmission unit 124.

The distribution determination unit 142 allocates one optical power feeding device 11 to one optical power reception device 12, but is not limited thereto. For example, the distribution determination unit 142 may determine that light transmitted from one optical power feeding device is allocated to a plurality of optical power reception devices.

The power storage data transmission unit 124 and the switch control apparatus 14 of the optical power reception device 12 in the above-described embodiment may be realized by a computer. In that case, a program for implementing this function may be recorded in a computer-readable recording medium, and the program recorded in the recording medium may be read and executed by a computer system to implement the function. Note that the “computer system” mentioned herein includes an OS and hardware such as peripheral devices. In addition, the “computer-readable recording medium” refers to a portable medium such as a flexible disk, a magneto-optical disc, a ROM, or a CD-ROM, or a storage device such as a hard disk included in the computer system. Further, the “computer-readable recording medium” may include a medium that dynamically stores the program for a short time, such as a communication line in a case where the program is transmitted via a network such as the Internet or a communication line such as a telephone line, and a medium that stores the program for a certain period of time, such as a volatile memory inside the computer system serving as a server or a client in that case. Also, the program may be for implementing a part of the function described above, may be implemented in a combination of the function described above and a program already recorded in the computer system, or may be implemented with a programmable logic device such as a field programmable gate array (FPGA).

### REFERENCE SIGNS LIST

1 Optical power feeding system
11 Optical power feeding device
12 Optical power reception device
13 Optical power supply switch
14 Switch control apparatus
121 Light conversion unit
122 Power storage unit
123 Power storage amount measurement unit
124 Power storage data transmission unit
141 Power storage data reception unit
142 Distribution determination unit
143 Switch control unit

1. A switch control apparatus comprising:
a processor; and
a storage medium having computer program instructions stored thereon, when executed by the processor, perform to:
connects a plurality of optical power feeding devices and a plurality of optical power reception devices that convert light received from the plurality of optical power feeding devices into power and store the power, and controls an optical power supply switch that switches an emission destination of light emitted from the optical power feeding devices;
receives data of a power storage amount stored by the plurality of optical power reception devices; and
determines a distribution of light emitted from the plurality of optical power feeding devices to the plurality of optical power reception devices based on data of the power storage amount, and controls the optical power supply switch based on the distribution determined by the distribution determination unit.

2. The switch control apparatus according to claim 1, wherein the computer program instructions further perform to determines a distribution such that the optical power reception device having a smaller power storage amount receives more light from the optical power feeding device.

3. The switch control apparatus according to claim 1, wherein
the optical power supply switch includes a coupler having an input side connected to all the optical power feeding devices and an output side connected to one optical power reception device, and
the coupler multiplexes the light transmitted from the optical power feeding device using mode multiplexing, polarization multiplexing, or wavelength multiplexing.

4. An optical power feeding system comprising:
a plurality of optical power feeding devices that transmit light;
a plurality of optical power reception devices that convert light received from the plurality of optical power feeding devices into power and store the power;
an optical power supply switch that connects the plurality of optical power feeding devices and the plurality of optical power reception devices and switches an emission destination of light emitted from the optical power feeding devices;
a switch control unit that controls the optical power supply switch;
a power storage data reception unit that receives data of a power storage amount stored by the plurality of optical power reception devices; and
a distribution determination unit that determines a distribution of light emitted from the plurality of optical power feeding devices to the plurality of optical power reception devices based on data of the power storage amount received by the power storage data reception unit, wherein
the switch control unit controls the optical power supply switch based on the distribution determined by the distribution determination unit.

5. A switch control method comprising:
a switch control step of connecting a plurality of optical power feeding devices and a plurality of optical power reception devices that convert light received from the plurality of optical power feeding devices into power and store the power, and controlling an optical power supply switch that switches an emission destination of light emitted from the optical power feeding devices;
a power storage data reception step of receiving data of a power storage amount stored by the plurality of optical power reception devices; and
a distribution determination step of determining a distribution of light emitted from the plurality of optical power feeding devices to the plurality of optical power reception devices based on data of the power storage amount received by the power storage data reception step, wherein
in the switch control step, the optical power supply switch is controlled based on the distribution determined in the distribution determination step.
